(19) United States
(12) Patent Application Publication
(10) Pub. No.: US 2020/0325267 A1
(43) Pub. Date: Oct. 15, 2020

(54) METHOD FOR PRODUCING A COMPOSITION CONTAINING ISOCYANATE AND ISOCYANURATE GROUPS AND PUR/PIR RIGID FOAM PRODUCED THEREFROM

(71) Applicant: Covestro Deutschland AG, Leverkusen (DE)

(72) Inventors: Hans-Detlef Arntz, Overath (DE); Stephan Schleiermacher, Pulheim (DE)

(21) Appl. No.: 16/304,982

(22) PCT Filed: Jun. 14, 2017
(86) PCT No.: PCT/EP2017/064514

§ 371 Date: Nov. 27, 2018

(30) Foreign Application Priority Data
Jun. 17, 2016 (EP) 16174907.2

(51) Int. Cl. C08G 18/09; C08G 18/02; C08G 18/18; C08G 18/22; C08G 18/42; C08G 18/76; C08G 18/79

(52) U.S. Cl. CPC C08G 18/092; C08G 18/022; C08G 18/1825; C08G 2101/0025; C08G 18/4208; C08G 18/7671; C08G 18/794; C08G 18/225

(57) ABSTRACT

The present disclosure relates to a method for producing a composition containing isocyanate and isocyanurate groups having the following steps: 1) mixing a monomer polyisocyanate with polymer diphenylmethane diisocyanate, thereby obtaining a mixture, and 2) allowing the mixture obtained in step 1) to react in the presence of a trimerization catalyst, thereby obtaining a composition containing isocyanate and isocyanurate groups. The monomer polyisocyanate used in step 1) has a total chlorine content of <100 ppm (determined using an X-ray fluorescence analysis according to DIN 51577 (1994) part 4). The present disclosure further relates to compositions which can be obtained using the aforementioned method, to the production of PUR/PIR rigid foams made of the compositions, to the rigid foams themselves, and to the use of such rigid foams.

The present invention relates to a process for producing compositions containing isocyanate and isocyanurate groups with partial trimerization. It also relates to compositions obtainable by this process, the production of rigid PUR/PIR foams from these compositions, the rigid foams themselves and the use of such rigid foams.

To produce thermally insulating foams as are used in the cladding of external walls of buildings, increasing use is made of polyisocyanurate-polyurethane foam systems (PUR/PIR foams) which are produced by a significantly, based on the polyol component, superstoichiometric use of the polymeric polyisocyanate customary for rigid foam production in order to improve fire safety. Polymeric polyisocyanates frequently have, due to the method of production, chlorine contents of less than 5000 ppm but significantly more than 1000 ppm. The high proportion by mass of the isocyanate in the PIR foam therefore quickly leads to high halogen or chlorine contents above 1000 ppm. However, regulations for erecting public buildings are increasingly giving preference to materials having a demonstrably low halogen content.

One possible way of reducing the halogen content in PUR/PIR foams is treatment of the isocyanates after they have been synthesized. EP 0 816 333 A1 describes, for example, a hydrogenation process of the still solvent-containing crude MDI which follows the phosgenation; this hydrogenation process leads not only to a lightening of the color of the product but also to a reduction in the content of hydrolyzable chlorine.

U.S. Pat. No. 4,743,627 is basically also directed at the lightening of the color of PUR/PIR foams. The process described there comprises the steps: (a) trimerization of polymeric MDI in the presence of a trimerization catalyst to given an isocyanurate-containing polyisocyanate; (b) deactivation of the trimerization catalyst; and (c) mixing of the isocyanurate-containing polyisocyanate with monomeric MDI to form an end product which has a viscosity comparable to the viscosity of a standard pMDI and has a two-ring content of at least 60% by weight. The end product is used in the production of foams which have a lighter color than foams of this type based on standard pMDI.

US 2009/105359 AA relates to a process for producing a liquid, isocyanurate-modified pMDI having a controlled viscosity. The process comprises the following steps: (a) trimerization of conventional pMDI having a viscosity in the range between 30 and 300 cps in the presence of a trimerization catalyst to give an isocyanurate-containing pMDI having a viscosity at 25° C. in the range from 2000 mPas to 200 000 mPas; (b) deactivation of the catalyst to give a mixture containing isocyanurate-modified pMDI and deactivated catalyst by means of a catalyst deactivator; and (c) mixing of the mixture from step (b) with an amount of conventional pMDI which is sufficient to give a mixture having a viscosity at 25° C. in the range from 2000 mPas to 200 000 mPas and a content of free NCO groups which is comparable with conventional pMDI. The “Yantai PM-200” (corresponds to Wannate PM-200) used in the examples has, according to the data sheet, a content of hydrolyzable chlorine, which is below the total chlorine content, of <2000 ppm. The content of hydrolyzable chlorine corresponds to the acidity of HCl in the isocyanate, which is determined mainly by the amount of HCl present as carbamoyl chloride, but is generally significantly higher in the case of conventional pMDI, like the Yantai PM-200 used here. WO 2017/046274 A by the applicant relates to a process for producing rigid polyurethane-polyisocyanurate foams (rigid PUR/PIR foams) using partially trimerized isocyanate blends. This patent application also relates to the rigid polyurethane-polyisocyanurate foams obtainable in this way and also the use thereof in the production of composite elements composed of the rigid polyurethane-polyisocyanurate foams and suitable covering layers. This patent application further provides the composite elements obtainable in this way.

There continues to be a need for simplified processes for producing low-halogen A components for PUR/PIR systems. It is an object of the present invention to provide such a process.

According to the invention, the object is achieved by a process for producing a composition containing isocyanate and isocyanurate groups, which comprises the steps:
1) mixing a monomeric polyisocyanate with polymeric diphenylmethane diisocyanate to give a mixture;
2) allowing the mixture obtained in step A) to react in the presence of a trimerization catalyst to give a composition containing isocyanate and isocyanurate groups;
   wherein the monomeric polyisocyanate used in step 1) has a total chlorine content of ≤100 ppm (determined by X-ray fluorescence analysis in accordance with DIN 51577 (1994) part 4).

Increased usage of low-halogen monomeric polyisocyanate grades in principle enables regulatory limit values for halogens to be adhered to in the rigid foam produced from the composition. The monomeric polyisocyanate used in step 1) preferably has a total chlorine content of ≤80 ppm, more preferably ≤50 ppm. The NCO functionality of the composition which has been decreased by this measure can be increased again to a value corresponding to polymeric MDI by means of partial trimerization of the (generally rather low-viscosity at from 20 to 25 mPas at 25° C.) mixture, so that neither foam production nor foam properties are adversely different from the standard grades.

It may be pointed out that the monomeric polyisocyanate and the polymeric diphenylmethane diisocyanate in step 1) originate from different sources. A commercial pMDI, which for technical reasons also contains monomeric MDI, does not represent the mixture obtained in step 1). The latter is only obtained when additional monomeric polyisocyanate, for example purified 4,4′-MDI, is added.

As monomeric polyisocyanates in step 1), use is made of the customary aliphatic, cycloaliphatic, araliphatic diisocyanates and/or polyisocyanates and in particular aromatic isocyanates which are known from polyurethane chemistry. Aromatic isocyanates, in particular the isomers of the MDI series (monomeric MDI) and also TDI, are particularly preferred.

For the purposes of the present patent application, “oligomeric MDI” refers to a polyisocyanate mixture of higher homologs of MDI which have at least three aromatic rings and a functionality of at least three.

The term “polymeric diphenylmethane diisocyanate”, “polymeric MDI” or pMDI is used in the context of the present invention to refer to a mixture of oligomeric MDI and optionally monomeric MDI. The monomer content of a polymeric MDI is typically in the range of 30-50% by weight, based on the total mass of the pMDI.

Suitable trimerization catalysts in step 2) are, for example, tris(dimethylaminomethyl)phenol, potassium acetate and/or aliphatic quaternary ammonium salts. The trimerization reaction can be stopped in a controlled manner by addition of a deactivator. An example thereof is benzoyl chloride.

The composition containing isocyanate and isocyanurate groups as is obtainable by the process of the invention can, as explained in more detail below, be used for producing PUR/PIR foams. In preferred cases, this occurs even without adaptation of a formulation.

Specific embodiments and further aspects of the present invention are indicated below. They can be combined with one another in any way, unless the contrary is clearly indicated by the context. If a measurement method is required for determining the characteristic values specified in this description, the measurement method mentioned or described in the examples is employed, unless clearly indicated otherwise.

In one embodiment, the monomeric polyisocyanate used in step 1) is a monomeric polyisocyanate which has been purified by distillation.

In a further embodiment, the monomeric polyisocyanate and the polymeric diphenylmethane diisocyanate are used in a weight ratio of from ≥40:60 to ≤80:20 in step 1). The weight ratio is preferably from ≥45:55 to ≤75:25.

In a further embodiment, the reaction in step 2) is stopped at a calculated isocyanurate content of from ≥10% by weight to ≤40% by weight, preferably from ≥20% by weight to ≤35% by weight. The percentage isocyanurate content of the composition obtained after step 2) (“isocyanurate % (A2)” in the formula below) can be determined from the decrease in NCO according to the following calculation when the proportion by weight of NCO groups in the mixture after step 1 (“NCO % in the starting blend A1” in the following formula) and the NCO content of a reaction sample (“NCO % in the product A2” in the following formula) are known:

$$Isocyanurate \% ( A 2 ) = \frac{\begin{matrix}( NCO \% in the starting blend A 1 ) - \\ ( NCO \% in the product A 2 )\end{matrix}}{0.5 \cdot ( NCO \% in the starting blend A 1 )} \cdot 100$$

The determination of the proportion by weight of NCO groups is carried out in accordance with EN ISO 11909:2007.

In a further embodiment, the reaction in step 2) is stopped at a viscosity of the resulting composition of ≤10 000 mPas, preferably ≤8000 mPas, at 25° C. (DIN EN ISO 3219:1994).

In a further embodiment, the monomeric polyisocyanate used in step 1) is diphenylmethane diisocyanate. It is preferably monomeric 4,4′-MDI. The mixture obtained in step 1) can, for example, have the following properties:
a total content of monomeric MDI of 55-80% by weight (based on the total weight of the mixture)
a viscosity of ≤30 mPas, preferably ≤28 mPas and particularly preferably <27 mPas, at 25° C. (DIN EN ISO 3219:1994)

The trimerization of pMDI having a high monomer content leads, at a degree of trimerization of ≥10%, to liquid, storage-stable isocyanate blends which can be reacted in existing plants to give insulation foams having the same quality (thermal conductivity, dimensional stability, compressive strength, etc.) as the foams obtained from the standard pMDI grades, with the halogen content remaining significantly below the required limit value.

In a further embodiment, the process further comprises the step:
3) adding polymeric diphenylmethane diisocyanate to the composition obtained after step 2).

A further aspect of the present invention is a composition which contains isocyanate and isocyanurate groups and is obtainable by a process according to the invention.

The invention likewise provides a process for producing a rigid PUR/PIR foam by reaction of a PUR/PIR system composed of an isocyanate component (A) and a polyol formulation (B) in the presence of blowing agents (C) and catalysts (D), wherein the isocyanate component (A) comprises a composition according to the invention containing isocyanate and isocyanurate groups.

The PUR/PIR systems are preferably used for the production of composite elements. Here, foaming usually takes place continuously or batchwise against at least one covering layer.

The rigid PUR/PIR foams are obtainable by reaction of the PUR/PIR system. In the reaction, isocyanate component A and the polyol formulation B are generally reacted in such amounts that the isocyanate index of the foam is from ≥300 to ≤500, preferably from ≥320 to ≤450, more preferably from ≥360 to ≤420.

Here, the isocyanate index (also referred to as index) is the ratio of the molar amount [mol] of isocyanate groups actually used and the molar amount [mol] of isocyanate groups which is stoichiometrically required for complete conversion of all isocyanate-reactive groups, multiplied by 100. Since one mole of an isocyanate group is required for reaction of one mole of an isocyanate-reactive group, the following equation applies:

Index=(mol of isocyanate groups/mol of isocyanate-reactive groups)·100

The components A and B of the polyurethane system are preferably selected so that the resulting foam has a compressive strength (at a foam density of 60 kg/m³) of greater than 0.2 N/mm², preferably greater than 0.25 N/mm², particularly preferably greater than 0.3 N/mm², measured in accordance with DIN 53421:1984-06.

The isocyanate component A can, for example, have the following properties:
15-25% by weight, preferably 18-25% by weight, of isocyanurate groups,
30-55% by weight, preferably 35-45% by weight, of monomeric MDI,
NCO content of 23-30% by weight (EN ISO 11909:2007),
in each case based on the total weight of the isocyanate component.

To produce the isocyanate component A, the composition according to the invention containing isocyanate and isocyanurate groups can optionally be blended with further isocyanates. As isocyanates, use is made of the customary aliphatic, cycloaliphatic, araliphatic diisocyanates and/or polyisocyanates and in particular aromatic isocyanates which are known from polyurethane chemistry, Aromatic isocyanates, in particular the homologs and isomers of the MDI series and also TDI, are particularly preferred. Furthermore, the isocyanates suitable for blending can be polyurethane prepolymers or modified isocyanates. The term “polyurethane prepolymer” refers, in particular, to reactive intermediates in the reaction of isocyanates to form polyurethane polymers. They are produced by reaction of a polyol component with an excess of an isocyanate component. Preferred modified isocyanates include: urea-modified isocyanates; biuret-modified isocyanates; urethane-modified isocyanates; isocyanurate-modified isocyanates; allophanate-modified isocyanates; carbodiimide-modified isocyanates; uretdione-modified isocyanates and uretonimine-modified isocyanates. Such modified isocyanates are commercially available and are prepared by reaction of an isocyanate with an amount of an isocyanate-reactive compound which is less than the stoichiometric amount or with itself.

As polyols for the polyol formulation B preference is given to using compounds based on polyesterols or polyetherols. The functionality of the polyetherols and/or polyesterols is generally from 1.9 to 8, preferably from 2.4 to 7, particularly preferably from 2.9 to 6.

The polyols have a hydroxyl number of greater than 70 mg KOH/g, preferably greater than 100 mg KOH/g, particularly preferably greater than 120 mg KOH/g. As upper limit to the hydroxyl number, 1000 mg KOH/g, preferably 900 mg KOH/g, particularly preferably 800 mg KOH/g, has generally been found to be useful. The OH numbers indicated above are based on the totality of the polyols in the polyol formulation B, which does not rule out individual constituents of the mixture having higher or lower values.

The polyol formulation B preferably contains polyether polyols which are prepared by known methods from one or more alkylene oxides having from two to four carbon atoms in the alkylene radical, for example by anionic polymerization in the presence of alkali metal hydroxides such as sodium or potassium hydroxide or alkali metal alkoxides such as sodium methoxide, sodium or potassium ethoxide or potassium isopropoxide as catalysts and with addition of at least one starter module containing from 2 to 8, preferably from 3 to 8, reactive hydrogen atoms in bound form or by cationic polymerization using Lewis acids such as antimony pentachloride, boron fluoride etherate, etc., or bleaching earth as catalysts. Suitable alkylene oxides are, for example, tetrahydrofuran, 1,3-propylene oxide, 1,2- or 2,3-butylene oxide, styrene oxide and preferably ethylene oxide and 1,2-propylene oxide. The alkylene oxides can be used individually, alternately in succession or as mixtures. Possible starter molecules are alcohols such as glycerol, trimethylolpropane (TMP), pentaerythritol, sucrose, sorbitol and also amines such as methylamine, ethylamine, isopropylamine, butylamine, benzylamine, aniline, toluidine, toluenediamine, naphthylamine, ethylenediamine, diethylenetriamine, 4,4′-methylenedianiline, 1,3-propanediamine, 1,6-hexanediamine, ethanolamine, diethanolamine, triethanolamine and the like. Furthermore, condensation products of formaldehyde, phenol and diethanolamine or ethanolamine, formaldehyde, alkylphenols and diethanolamine or ethanolamine, formaldehyde, bisphenol A and diethanolamine or ethanolamine, formaldehyde, aniline and diethanolamine or ethanolamine, formaldehyde, cresol and diethanolamine or ethanolamine, formaldehyde, toluidine and diethanolamine or ethanolamine and also formaldehyde, toluenediamine (TDA) and diethanolamine or ethanolamine and the like can be used as starter molecules. Preference is given to using TMP and TDA as starter molecule.

The polyol formulation B can contain crosslinkers as further constituent. For the purposes of the present invention, crosslinkers are compounds which have a molecular weight of from 60 to less than 400 g/mol and have at least three hydrogen atoms which are reactive towards isocyanates. An example thereof is glycerol. The crosslinkers are generally used in an amount of 1 to 10% by weight, preferably from 2 to 6% by weight, based on the total weight of the polyol formulation B (but without physical blowing agents).

The polyol formulation B can likewise contain chain extenders which serve to increase the crosslinking density. For the purposes of the present invention, chain extenders are compounds which have a molecular weight of from 60 to less than 400 g/mol and have two hydrogen atoms which are reactive towards isocyanates. Examples are butanediol, diethylene glycol, dipropylene glycol and ethylene glycol. The chain extenders are generally used in an amount of from 2 to 20% by weight, preferably from 4 to 15% by weight, based on the total weight of the polyol formulation B (but without physical blowing agents).

Crosslinkers and chain extenders can be used individually or in combination in the polyol mixture.

Furthermore, chemical and/or physical blowing agents C are used to produce the rigid PUR/PIR foams.

As chemical blowing agents, preference is given to water or carboxylic acids, in particular formic acid as chemical blowing agent. The chemical blowing agent is generally used in an amount of from 0.1 to 5% by weight, in particular from 1.0 to 3.0% by weight, based on the weight of the component B.

For the purposes of the present invention, physical blowing agents are compounds which are dissolved or emulsified in the starting materials for polyurethane production and vaporize under the conditions of polyurethane formation. They are, for example, hydrocarbons, halogenated hydrocarbons and other compounds, for example perfluorinated alkanes such as perfluorohexane, chlorofluorocarbons and also ethers, esters, ketones and/or acetals. These are usually employed in an amount of from 1 to 30% by weight, preferably from 2 to 25% by weight, particularly preferably from 3 to 20% by weight, based on the total weight of the component B.

Catalysts D are also used for producing the rigid PUR/PIR foams. As catalysts D, use is usually made of compounds which accelerate the reaction of the hydroxyl-containing compounds of the component B with the isocyanate groups of the component A.

Preference is given to organic tin compounds such as tin(II) salts of organic carboxylic acids and/or basic amine compounds, preferably tertiary amines such as triethylamine and/or 1,4-diazabicyclo[2,2,2]octane. The catalysts are generally used in an amount of from 0.001 to 5% by weight, in particular from 0.05 to 2.5% by weight, of catalyst, based on the weight of the component B.

Further auxiliaries and additives (E) can optionally also be incorporated into the reaction mixture. These are the customary auxiliaries and additives which are known in the prior art. Mention may be made by way of example of surface-active substances, foam stabilizers, cell regulators, fillers, dye, pigments, flame retardants, antistatics, hydrolysis inhibitors and/or fungistatic and bacteriostatic substances.

In one embodiment, the isocyanate component (A) is selected by means of the following steps:
selection of a formulation for an isocyanate component, where the formulation contains a polymeric diphenylmethane diisocyanate having a viscosity of ≥600 mPas at 25° C. (DIN EN ISO 3219:1994);
at least partial replacement of the polymeric diphenylmethane diisocyanate having a viscosity of ≥600 mPas at 25° C. (DIN EN ISO 3219:1994) in the formulation by a composition according to the invention.

The invention is likewise directed at a rigid PUR/PIR foam which is obtainable by a process according to the invention. For the purposes of the present invention, rigid PUR/PIR foams are, in particular, PUR/PIR foams which have a foam density in accordance with DIN EN ISO 3386-1-98 in the September 2010 version in the range from 15 kg/m³ to 300 kg/m³ and have a compressive strength in accordance with DIN EN 826 in the May 1996 version in the range from 0.1 MPa to 3 MPa.

A further aspect of the invention is the use of a rigid PUR/PIR foam according to the invention as insulating foam in the production of composite elements.

The invention likewise provides a composite element comprising a rigid foam layer containing a rigid PUR/PIR foam according to the invention and also at least one covering layer. The covering layer is here at least partly in contact with a layer comprising the rigid PUR/PIR foam according to the invention. The material of the covering layer is typically aluminum, steel, bitumen, paper, a mineral nonwoven, a nonwoven comprising organic fibers, a polymer plate, a polymer film and/or a wooden board.

In a further embodiment of the composite element, the element is the form of an insulation panel.

The invention will be illustrated with the aid of the following examples, but without being restricted thereto.

### Materials Used:

Desmodur 44M: diphenylmethane 4,4′-diisocyanate purified by distillation (Covestro); isocyanate content 33.6% by weight; total chlorine content determined by a method based on the oxidative microcoulometry method of DIN EN 14077:2003 of less than 50 ppm

Desmodur 44V20L: polymeric diphenylmethane diisocyanate (Covestro); isocyanate content 31.5% by weight, viscosity at 25° C. about 200 mPas

Desmodur 44V70L: polymeric diphenylmethane diisocyanate (Covestro); isocyanate content 30.9% by weight, viscosity at 25° C. about 700 mPas

Benzoyl chloride: procured from Sigma-Aldrich; 99.5% pure; boiling point 198° C.

Tris(dimethylaminomethyl)phenol: procured from Sigma-Aldrich 95% pure; index of refraction n20/D 1.516, boiling point: 130-135° C.

Polyol 1: aromatic polyester diol having an OH number of 240 mg KOH/kg and a viscosity of 15 600 mPas at 25° C.

Triethyl phosphate: flame retardant (Lanxess)

Tegostab B8421: foam stabilizer (Evonik)

Desmorapid 1792: potassium acetate catalyst (Covestro)

### Production of the Isocyanate Mixture A1 (Isocyanate Mixture Before Trimerization)

Desmodur 44M and Desmodur 44V20L (batch size 3 kg, weight ratio 40:60) were transferred under nitrogen into a 5 l three-neck flask provided with a stirrer and homogenized at room temperature. The isocyanate mixture A1 obtained had a viscosity of about 25 mPas at 25° C.

| | | Isocyanate | Parts by |
|---|---|---|---|
| | Unit | content | weight |
| Desmodur 44M | Parts by weight | 33.6 | 60.00 |
| Desmodur 44V20L | Parts by weight | 31.5 | 40.00 |
| Isocyanate mixture A1 | | | 100 |

### Production of an Isocyanurate-Containing Isocyanate Blend (A2)

The previously produced isocyanate mixture A1 was heated under nitrogen to a temperature of 60-80° C. and subjected to a trimerization reaction catalyzed by 2,4,6-tris(dimethylaminomethyl)phenol (900 ppm). Samples were taken from the reaction mixture at time intervals of about 15 minutes in order to determine the isocyanate content. A decrease in the NCO value, which was linear over time under the reaction conditions, made it possible to get a good estimate of the reaction time (about two hours) necessary to attain the target NCO value. On reacting an isocyanate content of 26.2% by weight, the reaction was stopped by addition of benzoyl chloride (200 ppm). The isocyanurate content of the resulting isocyanate blend A2 (isocyanurate % (A2)) was determined from the NCO decrease according to the following calculation:

$$Isocyanurate \% ( A 2 ) = \frac{\begin{matrix}( NCO \% in the starting blend A 1 ) - \\ ( NCO \% in the product A 2 )\end{matrix}}{0.5 \cdot ( NCO \% in the starting blend A 1 )} \cdot 100$$

From the product A2 obtained, mixtures with Desmodur 44V20L or Desmodur 44V70L were produced as blend I and blend II, respectively. The properties are shown in the following table:

TABLE 1

| | | NCO | Product | Blend | Blend |
|---|---|---|---|---|---|
| | Unit | [%] | A2 | I | II |
| Desmodur 44M | Parts by weight | 33.6 | 60.00 | | |
| Desmodur 44V20L | Parts by weight | 31.5 | 40.00 | 16.65 | |
| Desmodur 44V70L | Parts by weight | 30.9 | | | 16.65 |
| Product A2 | Parts by weight | 28.2 | | 83.35 | 83.35 |
| Total | Parts by weight | | 100.00 | 100.00 | 100.00 |
| Isocyanate content | [% by weight] | | 28.2 | 28.4 | 28.4 |
| Viscosity at 25° C. [mPas] | [mPa*s] | | n.d. | 603 | 673 |
| Isocyanurate content (calculated) | [% by weight] | | 27.8 | 23.2 | 23.2 |
| Total halogen content | | | 486 | 640 | 710 |

The isocyanurate-containing blends I and II produced in this way are processed with a standard rigid PUR/PIR foam polyol formulation.

In the following table, the results are compared with those obtained from the same polyol formulation in combination with Desmodur 44V70L. Examples 1 and 2 are examples according to the invention.

TABLE 2

| Parameter | Unit | Comp. | Example 1 | Example 2 |
|---|---|---|---|---|
| Polyol 1 | Parts by weight | 63.5 | 63.5 | 63.5 |
| Triethyl phosphate | Parts by weight | 15 | 15 | 15 |
| Tegostab B8421 | Parts by weight | 2 | 2 | 2 |
| Water | Parts by weight | 0.8 | 0.8 | 0.8 |
| Desmorapid 1792 | Parts by weight | 3.6 | 2.8 | 2.8 |
| n-pentane | Parts by weight | 18 | 18 | 18 |
| Desmodur 44V70L | Parts by weight | 223 | | |
| Blend I | Parts by weight | | 223 | |
| Blend II | Parts by weight | | | 223 |
| Index (100 NCO/OH) | | 395 | 373 | 373 |
| Cream time | s | 9 | 8 | 9 |
| Fiber time | s | 43 | 39 | 42 |
| Tack-free time | s | 60 | 55 | 60 |
| Core foam density | kg/m³ | 31.0 | 30.8 | 30.7 |
| Surface | | tough | tough | tough |
| Foam interior surface | | tough | tough | tough |
| Cell size | | 2 | 2 | 2 |
| Cell structure | | 2.5 | 2.5 | 2.5 |
| Dim. stab. temperature | ° C. | 100 | 100 | 100 |
| Dim. stab. 24 h L1 | % | 0.7 | 0.3 | 0.3 |
| Dim. stab. 24 h L2 | % | 0.6 | 0.3 | 0.5 |
| Dim. stab. 24 h D | % | −0.5 | −0.4 | −0.4 |
| Dim. stab. temperature | ° C. | −22 | −22 | −22 |
| Dim. stab. 24 h L1 | % | 0.0 | −0.1 | 0.0 |
| Dim. stab. 24 h L2 | % | −0.2 | 0.0 | 0.0 |
| Dim. stab. 24 h D | % | 0.0 | 0.1 | 0.1 |
| Application of flame to edge in | | Foam | Foam | Foam |
| accordance with EN11925-2: 2010 | | | | |
| Average of the greatest flame heights | mm | 155 | 148 | 148 |
| Greatest flame height test specimen 1 | mm | 160 | 145 | 145 |
| Greatest flame height test specimen 2 | mm | 150 | 150 | 145 |
| Greatest flame height test specimen 3 | mm | 155 | 150 | 150 |
| Greatest flame height test specimen 4 | mm | 155 | 145 | 150 |
| Classification according to | | F | E | E |
| EN 13501-1: 2010 | | | | |
| Total halogen content | ppm | 1150 | 440 | 490 |

At the same amount of the isocyanate components used per 100 parts by weight of polyol formulation, the mixing index decreases as a result of the lower isocyanate content of the PIR blend compared to Desmodur 44V70L, but very similar, even better results are obtained in assessment of the foam. Especially in the case of the fire classification in accordance with EN11925 for standard flammable building materials, the class E is more reliably attained.

The experiments show that the use of isocyanurate-containing isocyanate blends makes it possible to produce low-halogen polyisocyanurate-polyurethane foams which are not inferior in terms of the physical/mechanical properties to foams produced from pMDI.

### Methods:

Cream time: the time in seconds which elapses from the commencement of mixing to the discernible start of the reaction.

Fiber time: the time in seconds which elapses from the commencement of mixing to solidification of the foam surface.

Tack-free time: the time in seconds which elapses from the commencement of mixing until the foam surface no longer feels sticky.

Cell size/cell structure: Scale between 1 and 6; where 1 means very fine and very uniform and 6 means very coarse and irregular.

Surface/foam interior surface: qualitative distinction between brittle, sandy and tough.

Core foam density: DIN EN ISO 845:2009 “Foams composed of rubber and polymer—Determination of the foam density”

Isocyanate content: EN ISO 11909:2007 “Determination of the isocyanate content”

Viscosity: DIN EN ISO 3219:1994 “Plastics—Polymers/resins in the liquid, emulsified or dispersed state”

Hydroxyl number (OH number): The determination of the OH number was carried out in accordance with the method of DIN 53240-1: 2007.

Dimensional stability (Dim.Stab.): The foam specimen is stored for at least 24 hours at 20-25° C. before two foam cubes having the dimensions 10·10·10 cm³ are taken from the core. After marking the three directions in space of each cube, the cubes were measured with a sliding caliper and one cube was stored at −22° C. and the other at 100° C. for 24 hours. Subsequently, the cubes were measured again at room temperature. The dimensional stability is the percentage change in the edge length εL in all three directions A, B and C, with C always corresponding to the foaming direction. εL=(L−OL)/OL·100% where L=edge length of the test specimen after storage, OL=edge length of the test specimen before storage. A foam has passed this test when the change in each direction at −22° C. and at 100° C. is less than 1%.

Total chlorine content or total halogen content:
a) Determination based on the oxidative microcoulometry method of DIN EN 14077:2003 (rigid foams)
b) Determination of the total chlorine and bromine content in accordance with DIN 51577 (1994) part 4 (X-ray fluorescence analysis of the polyisocyanates)

1. A process for producing a composition containing isocyanate and isocyanurate groups, which comprises the steps:
1) mixing a monomeric polyisocyanate with a polymeric diphenylmethane diisocyanate to give a mixture;
2) allowing the mixture obtained in step 1) to react in the presence of a trimerization catalyst to give a composition containing isocyanate and isocyanurate groups;
wherein the monomeric polyisocyanate used in step 1) has a total chlorine content of ≤100 ppm (determined by X-ray fluorescence analysis in accordance with DIN 51577 (1994) part 4).

2. The process as claimed in claim 1, wherein the monomeric polyisocyanate used in step 1) is a monomeric polyisocyanate which has been purified by distillation.

3. The process as claimed in claim 1, wherein, in step 1), the monomeric polyisocyanate and the polymeric diphenylmethane diisocyanate are used in a weight ratio of from ≥40:60 to ≤80:20.

4. The process as claimed in claim 1, wherein the reaction in step 2) is stopped at a calculated isocyanurate content of from ≥10% by weight to ≤40% by weight.

5. The process as claimed in claim 1, wherein the reaction in step 2) is stopped at a viscosity of the resulting composition of ≤10 000 mPas at 25° C. (DIN EN ISO 3219:1994).

6. The process as claimed in claim 1, wherein the monomeric polyisocyanate used in step 1) is diphenylmethane diisocyanate.

7. The process as claimed in claim 1 further comprising the step:
3) adding polymeric diphenylmethane diisocyanate to the composition obtained after step 2).

8. A composition containing isocyanate and isocyanurate groups which is obtainable by the process as claimed in claim 1.

9. A process for producing a rigid PUR/PIR foam by reaction of a PUR/PIR system composed of an isocyanate component (A) and a polyol formulation (B) in the presence of blowing agents (C) and catalysts (D),
wherein the isocyanate component (A) comprises a composition containing isocyanate and isocyanurate groups as claimed in claim 8.

10. A process for producing a rigid PUR/PIR foam by reaction of a PUR/PIR system composed of an isocyanate component (A) and a polyol formulation (B) in the presence of blowing agents (C) and catalysts (D),
wherein the isocyanate component (A) comprises a composition containing isocyanate and isocyanurate groups as claimed in claim 8,
wherein the isocyanate component (A) is selected by means of the following steps:
selection of a formulation for an isocyanate component, where the formulation contains a polymeric diphenylmethane diisocyanate having a viscosity of ≥600 mPas at 25° C. (DIN EN ISO 3219:1994); and
at least partial replacement of the polymeric diphenylmethane diisocyanate having a viscosity of ≥600 mPas at 25° C. (DIN EN ISO 3219:1994) in the formulation by a composition as claimed in claim 8.

11. A rigid PUR/PIR foam obtainable by a process as claimed in claim 9.

12. A method of using the rigid PUR/PIR foam as claimed in claim 11 as an insulating foam comprising producing composite elements.

13. A composite element comprising a rigid foam layer containing a rigid PUR/PIR foam as claimed in claim 11 and also at least one covering layer.

14. The composite element as claimed in claim 13, wherein the material of the covering layer is aluminum, steel, bitumen, paper, a mineral nonwoven, a nonwoven comprising organic fibers, a polymer plate, a polymer film and/or a wooden board.

15. The composite element as claimed in claim 14 in the form of an insulation panel.
